(19) United States
(12) Patent Application Publication
(10) Pub. No.: US 2025/0178124 A1
(43) Pub. Date: Jun. 5, 2025

(54) DEVICE AND METHOD FOR COUPLING A LASER BEAM INTO A DOUBLE-CLAD FIBER

(71) Applicant: TRUMPF Laser GmbH, Schramberg (DE)

(72) Inventors: Tina Gottwald, Eschbronn (DE); Bernd Metzger, Villingen-Schwenningen (DE); Christoph Wieschendorf, Villingen-Schwenningen (DE); Sebastian Pricking, St. Georgen - Peterzell (DE); Francesco D’Angelo, Mainz (DE); Sven-Silvius Schad, Rottweil (DE); Julian Hellstern, Rottweil (DE)

(21) Appl. No.: 19/044,642

(22) Filed: Feb. 4, 2025

Related U.S. Application Data
(63) Continuation of application No. PCT/EP2023/071600, filed on Aug. 3, 2023.

(30) Foreign Application Priority Data
Aug. 4, 2022 (DE) 10 2022 119 556.2

(51) Int. Cl. B23K 26/064; B23K 26/067; G02B 5/30; G02B 6/42; H01S 3/00

(52) U.S. Cl. CPC B23K 26/064; B23K 26/0676; G02B 5/3083; G02B 6/4296; H01S 3/005

(57) ABSTRACT

A device for coupling a laser beam into a double-clad fiber includes a first birefringent optical element configured to split the laser beam into two sub-laser beams polarized along base polarization components of the first birefringent optical element, a polarization rotation device configured to adjust a polarization of the sub-laser beams to provide polarization-adjusted sub-laser beams, a second birefringent optical element configured to split each of the polarization-adjusted sub-laser beams into two sub-sub-laser beams polarized along base polarization components of the second birefringent optical element, and an in-coupling optical unit configured to couple the sub-sub-laser beams with compensated first exit angles and/or first beam displacements into an inner core of the double-clad fiber, and to couple other sub-sub-laser beams into an annular core of the double-clad fiber.

### CROSS REFERENCE TO RELATED APPLICATIONS

This application is a continuation of International Application No. PCT/EP2023/071600 (WO 2024/028462 A1), filed on Aug. 3, 2023, and claims benefit to German Patent Application No. DE 10 2022 119 556.2, filed on Aug. 4, 2022. The aforementioned applications are hereby incorporated by reference herein.

### FIELD

Embodiments of the present invention relate to a device and a method for coupling a laser beam of a laser into a double-clad fiber.

### BACKGROUND

In recent years, the further development of laser systems has led to a new type of material machining that is based on applying the laser beam of a laser to a workpiece. In order to transport the laser beam from the typically stationary laser to a target location, the laser beam is often coupled into a multi-clad fiber, in particular a double-clad fiber. The target location can, for example, be a machining optical unit that shapes the laser beam and then applies the shaped laser beam to a workpiece to be machined.

An important machining process here is the separation and machining of workpieces, in which the laser beam can create a perforation in the workpiece along a separation line, along which the workpiece can be separated. Another important machining process is the joining of two joining partners, in which the laser beam is applied to the boundary surface between adjacent joining partners to produce a melt which, after solidification, forms a weld seam between the joining partners.

The different machining processes typically have different requirements for characteristic laser beam parameters, such as the focus diameter, the intensity distribution or the beam profile character at the machining point. A change in the machining process is therefore associated with a high degree of refitting effort for the optical system.

It is known from EP2556397 that the laser beam components coupled into the inner core or the outer core of the multi-clad fiber provide different beam profile characteristics and beam qualities in the out-coupled laser beam. For this purpose, the laser beam is split into two sub-laser beams by a mechanically retractable wedge switch, which sub-laser beams are coupled into different cores of the double-clad fiber. However, the use of a wedge switch to adjust the beam quality is mechanically complex and requires a lot of adjustment.

U.S. Ser. No. 10/914,902 shows further different variants for in-coupling of a laser beam into a double-clad fiber, in which polarization splitting of an incident laser beam is achieved by means of birefringent elements, and the two resulting sub-laser beams are imaged into different cores of the double-clad fiber.

### SUMMARY

Embodiments of the present invention provide a device for coupling a laser beam of a laser into a double-clad fiber. The device includes a first birefringent optical element configured to split the laser beam incident on a beam entry surface into two sub-laser beams. The two sub-laser beams have first exit angles and/or first beam displacements with respect to a beam exit surface normal. The two sub-laser beams are polarized along base polarization components of the first birefringent optical element. The device further includes a polarization rotation device configured to adjust a polarization of the sub-laser beams to provide polarization-adjusted sub-laser beams, and a second birefringent optical element. A beam exit surface of the second birefringent optical element is first passed through by the polarization-adjusted sub-laser beams. The first exit angles and/or the first beam displacements of the sub-laser beams from the first birefringent optical element are second angles of impingement and/or second beam displacements of the polarization-adjusted sub-laser beams relative to a beam exit surface normal of the second birefringent optical element. The second birefringent optical element is configured to split each of the polarization-adjusted sub-laser beams into two sub-sub-laser beams. The two sub-sub-laser beams have second exit angles and/or second beam displacements with respect to a beam entry surface normal of the second optical wedge. The two sub-sub-laser beams are polarized along base polarization components of the second birefringent optical element. The second exit angles and/or the second beam displacements of the sub-sub-laser beams, a polarization of which corresponds to the polarization of the two sub-laser beams, compensate for the respective first exit angles and/or the first beam displacements. The device further includes an in-coupling optical unit configured to couple the sub-sub-laser beams with a compensated first exit angles and/or first beam displacements into an inner core of the double-clad fiber, and to couple other sub-sub-laser beams into an annular core of the double-clad fiber.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1A, FIG. 1B, FIG. 1C and FIG. 1D show a schematic representation of a birefringent optical element according to some embodiments;

FIG. 2A and FIG. 2B show a schematic representation of the beam path between two birefringent optical elements according to some embodiments;

FIG. 3A, FIG. 3B, FIG. 3C, FIG. 3D, FIG. 3E and FIG. 3F show a schematic representation of the beam path between two birefringent optical elements when the polarization of the sub-laser beams is adjusted with a polarization rotation device, according to some embodiments;

FIG. 4A, FIG. 4B and FIG. 4C show a schematic representation of the in-coupling of the sub-sub-laser beams into a double-clad fiber with an in-coupling optical unit according to some embodiments; and

FIG. 5A and FIG. 5B show a schematic representation of a system for machining a material according to some embodiments.

### DETAILED DESCRIPTION

Embodiments of the present invention provide an improved device for the in-coupling of a laser beam, as well as a corresponding method.

Accordingly, a device is proposed for coupling a laser beam of a laser into a double-clad fiber, having a first birefringent optical element, in particular an optical wedge or a plane-parallel plate, which is designed to split the laser beam incident on the beam entry surface into two sub-laser beams, wherein the two sub-laser beams have first exit angles and/or first beam displacements with respect to the beam exit surface normal, wherein the two sub-laser beams are polarized along the base polarization components of the first birefringent optical element, having a polarization rotation device which is designed to adjust the polarization of the impinging sub-laser beams and thus to provide polarization-adjusted sub-laser beams, having a second birefringent optical element, wherein the beam exit surface of the second birefringent optical element is first passed through by the polarization-adjusted sub-laser beams, and wherein the first exit angles and/or the first beam displacements of the sub-laser beams from the first birefringent optical element are the second angles of impingement and/or the second beam displacements of the polarization-adjusted sub-laser beams relative to the beam exit surface normal of the second birefringent optical element, wherein the second birefringent optical element is designed to split the polarization-adjusted sub-laser beams each into two sub-sub-laser beams, wherein the two sub-sub-laser beams each have second exit angles and/or second beam displacements with respect to the beam entry surface normal of the second birefringent optical wedge, wherein the two sub-sub-laser beams are each polarized along the base polarization components of the second birefringent optical element, and wherein the second exit angles and/or the second beam displacements of the sub-sub-laser beams, the polarization of which corresponds to that of the original sub-laser beams, compensate for the respective first exit angles and/or the first beam displacements, and having an in-coupling optical unit, which is designed to couple the sub-sub-laser beams with a compensated first exit angle and/or first beam displacements into the inner core of the double-clad fiber and to couple the other sub-sub-laser beams into the annular core of the double-clad fiber.

The laser can be a continuous-wave laser or a pulsed laser, in particular an ultrashort pulse laser.

A continuous-wave laser provides a continuous laser beam so that laser energy is transported continuously along the laser beam.

In contrast to this, the pulsed laser provides laser energy only during particular time intervals, the length of which is the pulse length. The energy transport by the laser pulses likewise takes place along the laser beam in this case. In particular, a pulsed laser may also be an ultrashort pulse laser, in which case the pulse duration of the laser pulses may be less than 10 ps, preferably less than 1 ps.

Instead of individual laser pulses, the laser may also, for example, provide bursts, each burst comprising the emission of a plurality of laser pulses. For a particular time interval, the emissions of the laser pulses may in this case follow one another very closely, with a spacing of from a few picoseconds to hundreds of nanoseconds. The bursts may in particular be so-called GHz bursts, in which case the sequence of the successive laser pulses of the burst takes place in the GHz range.

The wavelength of the laser beam may be, for example, between 200 nm and 2000 nm, preferably 257 nm or 343 nm or 515 nm or 1030 nm.

A birefringent optical element comprises a beam entry surface and a beam exit surface, and the birefringent optical element itself may comprise or consist of a birefringent material. In particular, a birefringent optical element can be designed as a wedge or as a plane-parallel plate. The optical wedge transitions into a plane-parallel plate by parallelizing the beam entry surface and beam exit surface, so an optical wedge can also be understood as a generic term for optical wedges and plane-parallel plates.

Birefringence means the ability of an optical material to separate the incident laser beam into two sub-laser beams polarized perpendicular to one another. This occurs because of the anisotropy of the refractive indices of the optical material according to the polarization and the angle of incidence of the light relative to the optical axis of the optical material.

If a laser beam impinges on a beam entry or beam exit surface of a birefringent optical element, the polarization of the incident laser beam is projected onto the optical axis of the optical material of the birefringent optical element, whereby the laser beam is split into sub-laser beams according to its polarization components, the sub-laser beams being polarized along the base polarization states of the birefringent optical element.

The sub-laser beams can leave the beam entry or beam exit surface of the birefringent optical element at an exit angle with respect to the beam entry surface normal or beam exit surface normal, such that the sub-laser beams are spatially separated by propagation through the birefringent optical element. In particular, the exit angles of the sub-laser beams can be different, such that the sub-laser beams have an angular displacement from one another.

The exit angles of the sub-laser beams depend, for example, on the anisotropy of the refractive indices, and the beam entry surface is preferably parallel to the optical axis of the optical material.

However, the exit angles can also be influenced by the fact that the beam exit surface of the birefringent optical element is inclined at an angle to the beam entry surface and/or to the optical axis of the optical material.

However, it is also possible that the sub-laser beams leave the birefringent optical element with a beam displacement. Then the sub-laser beams run parallel to the incident laser beam, but the sub-laser beams are spaced apart from each other perpendicular to the beam propagation direction. In particular, in such a case the first exit angle can also be 0°.

In particular, it is also possible for the sub-laser beams to have a first exit angle and a first beam displacement.

In general, the splitting of the sub-laser beams depends on the orientation of the optical axis of the birefringent crystal, the magnitude of the anisotropy, the angular inclination of the beam exit surface relative to the optical axis and the angle of impingement of the laser beam on the beam entry surface and/or beam exit surface.

A first birefringent optical element is arranged in front of the polarization rotation device in the beam propagation direction.

The first birefringent optical element is designed to split the laser beam incident on the beam entry surface into two sub-laser beams, the two sub-laser beams having first exit angles and/or first beam displacements relative to the beam exit surface normal, and the two sub-laser beams being polarized along the base polarization components of the first birefringent optical element.

For example, a first sub-laser beam can be s-polarized and have an exit angle of −10° with respect to the beam exit surface normal and a second sub-laser beam can be p-polarized and have an exit angle of 20° with respect to the beam exit surface normal.

For example, a first sub-laser beam can be p-polarized and have a beam displacement of 0 mm, while the second sub-laser beam is s-polarized and has a beam displacement of 2 mm or 5 μm.

The polarization rotation device is arranged after the first birefringent optical element so that the sub-laser beams in the base polarization states with the first exit angles pass through the polarization rotation device. Owing to the spatial separation of the sub-laser beams in the first birefringent optical element, the sub-laser beams also impinge on the polarization rotation device at different locations. However, the effect of the polarization rotation device is independent of the angle of impingement and the impingement location.

A polarization rotation device makes it possible to modify the polarization of the incident sub-laser beams. A modification may consist in generating a sub-laser beam in a final polarization state from a sub-laser beam in a defined initial polarization state. Overall, the polarization rotation device rotates the electric field vector of the sub-laser beams by an angle about the beam propagation direction. By modifying the polarization, the sub-laser beams become polarization-adjusted sub-laser beams.

For example, a p-polarized polarization-adjusted sub-laser beam can be generated from an s-polarized sub-laser beam. For example, an s-polarized polarization-adjusted sub-laser beam can be generated from a p-polarized sub-laser beam. However, it is also possible for the s-polarized and p-polarized sub-laser beams to be transferred into a final polarization state in which both polarization-adjusted sub-laser beams are partially s-polarized and partially p-polarized. The polarization rotation device can also allow the sub-laser beams to pass through without the polarization being modified. Such sub-laser beams are also polarization-adjusted sub-laser beams.

A polarization rotation device can also be a phase element, for example a lambda/4 plate, which generates a circularly polarized laser beam from a linearly polarized laser beam, and vice versa.

The second birefringent optical element is arranged behind the polarization rotation device in the beam propagation direction, and the beam exit surface of the second birefringent optical element is first passed through by the polarization-adjusted sub-laser beams. The second optical wedge is therefore passed through backwards by the polarization-adjusted sub-laser beams.

The polarization-adjusted sub-laser beams impinge on the beam exit surface of the second birefringent optical element at the first exit angle and/or the first beam displacement, and the first exit angles and/or the first beam displacements of the polarization-adjusted sub-laser beams are the second angles of impingement and/or the second beam displacements of the polarization-adjusted sub-laser beams relative to the beam exit surface normal of the second birefringent optical element.

The beam exit surface of the second birefringent optical element is understood to be the surface of the second birefringent optical element which is arranged at an angle with respect to the optical axis. The polarization-adjusted sub-laser beams that have left the first birefringent optical element impinge on this first.

In the simplest case, the second birefringent optical element is identical to the first birefringent optical element and rotated by 180° in the beam path. In other words, the beam exit surfaces of the first and second birefringent optical elements, which beam exit surfaces are beveled with respect to the optical axis, face each other, whereas the optical axes of the birefringent optical elements are (anti)parallel with respect to each other.

The second birefringent optical element splits the polarization-adjusted sub-laser beams each into two sub-sub-laser beams, and the two sub-sub-laser beams each have second exit angles and/or second beam displacements with respect to the beam entry surface normal of the second birefringent optical element, and the two sub-sub-laser beams are polarized along the base polarization components of the second birefringent optical element. The description of this effect is analogous to the first birefringent optical element.

The second exit angles and/or the second beam displacements of the sub-sub-laser beams, the polarization of which corresponds to that of the original sub-laser beams, compensate for the respective first exit angles and/or the first beam displacements.

This means, for example, that a sub-sub-laser beam of a first polarization, which comes from a sub-laser beam of a first polarization, at the beam entry surface of the second birefringent optical element has a second exit angle which is opposite and equal to the exit angle of the sub-laser beam at the beam exit surface of the first birefringent optical element. The polarization-adjusted sub-laser beams pass through the second birefringent optical element as if they were passing through the first birefringent optical element backwards, but only if the polarization of the polarization-adjusted sub-laser beam and the angle of impingement correspond to the component emerging from the first birefringent optical element. The description for the beam displacements is analogous.

For example, in a first simple example, the polarization rotation device can rotate the polarization of the sub-laser beams by 0°. Then, according to the above example, the s-polarized sub-laser beam has an exit angle of −10° and the p-polarized sub-laser beam has an exit angle of +20°. Owing to the spatial distance between the first birefringent optical element and the second birefringent optical element, the two sub-laser beams impinge on the second birefringent optical element at different locations. The two sub-laser beams also impinge at an angle of −10° and 20° on the beam exit surface of the second birefringent optical element. As a result, both sub-laser beams are deflected so that behind the second birefringent optical element they run parallel to each other, but also parallel to the incident laser beam. The first exit angles were compensated for accordingly by the second exit angles.

For example, the polarization rotation device can rotate the polarization of the sub-laser beams by 45°. Then the first polarization-adjusted sub-laser beam and the second polarization-adjusted sub-laser beam have mixed polarizations, i.e., they have p-polarization and s-polarization components. For example, the first polarization-adjusted sub-laser beam impinges on the beam exit surface of the second birefringent optical element at an angle of impingement of −10°. The component of the laser beam having polarization that corresponds to that of the original laser beam, i.e., the s-component, can pass through the second birefringent optical element backwards, as it were. The p-polarized component of the first polarization-adjusted sub-laser beam, however, is deflected. Conversely, in the second polarization-adjusted sub-laser beam, the p-polarized component is guided backwards through the second birefringent optical element, while the s-component is deflected.

By adjusting the polarization rotation device, the laser power can be distributed between the sub-sub-laser beams that have a compensated first exit angle and the other sub-sub-laser beams.

The in-coupling optical unit makes it possible to transfer the sub-sub-laser beams provided by the second birefringent optical element into different focal zones, in particular into the inner core or the annular core of a double-clad fiber. In particular, the sub-sub-laser beams with a compensated first exit angle are introduced into the inner core of the double-clad fiber, while the other sub-laser beams are introduced into the ring of the double-clad fiber.

The in-coupling optical unit can comprise a lens and/or a lens system and/or a mirror arrangement. The in-coupling optical unit may also comprise a collimation lens and a focusing lens.

The collimation lens in this case is designed to convert beam bundles of non-parallel sub-beams, in particular divergent sub-beams, into parallel sub-beams. In particular, the sub-sub-laser beams with an uncompensated exit angle can be parallelized by a collimation lens.

The focusing lens can transfer the sub-beams of a beam bundle into a focal zone. In particular, this makes it possible to transfer different beam bundles, such as those of the sub-sub-laser beams provided by the second birefringent optical element, into different focal zones.

A double-clad fiber with two cores has an inner fiber core and an intermediate cladding which surrounds said fiber core and is as thin and low-refractive as possible. This is followed by a single outer annular core, which is also surrounded by a low-refractive second cladding. On top of this, another layer of glass can follow, which determines the outer diameter of the fiber but has no influence on its function in terms of beam guidance. The final layer can be a coating made of a plastic material, such as silicone and/or nylon, which serves to protect the fiber.

By using a double-clad fiber, different beam profile characteristics at the fiber output can be selected depending on the in-coupling into the inner fiber core, into the outer annular core or both into the inner fiber core and into the outer annular core.

A double-clad fiber is a special case of a multi-clad fiber with N cores, a multi-clad fiber comprising at least one double-clad fiber. For example, a multi-clad fiber may comprise three cores, namely an inner core, an outer annular core and a middle annular core, the middle annular core enclosing the inner core and being disposed between the inner core and the outer core. For example, the inner core and the outer core can then form the double-clad fiber. However, it is also possible for the middle core and the outer core to form the double-clad fiber or for the inner core and the middle core to form the double-clad fiber. By combining a plurality of first and second birefringent elements and polarization rotation devices, the intensity of the sub-laser beams in the N cores of a multi-clad fiber can also be adjusted.

The splitting ratio with which the laser beam is coupled into the core and into the inner core and into the annular core of the double-clad fiber can be adjusted with the polarization rotation device. The splitting ratio can be determined from the ratio of the powers of those sub-sub-laser beams that have polarization corresponding to that of the original sub-laser beams and the powers of the other sub-sub-laser beams.

By using a polarization rotation device, in particular a continuous adjustment of the splitting ratio can be achieved. In comparison with the prior art, the mechanical effort is drastically reduced, which in particular results in a device that is stable in terms of adjustment.

For example, the total laser power can be coupled into the core of the double-clad fiber if the polarization rotation device does not rotate the polarization of the sub-laser beams. For example, the entire laser power can be coupled into the outer core of the double-clad fiber if the polarization rotation device rotates the polarization of the sub-laser beams by 90°. In particular, all other power ratios can also be adjusted by adjusting the polarization rotation device.

The splitting ratio can be used to adjust the beam quality of the laser beam after the double-clad fiber.

In the case of material machining using laser radiation, in particular when using high power in the kW range, switching between the in-coupling variants allows, for example, the choice between a comparatively good beam quality with a sharp focus, as is required for a laser cutting process, and a “reduced” beam quality with an almost uniform intensity distribution in the beam cross-section, which is particularly suitable for welding processes.

In order to obtain a high laser beam quality, the laser beam is coupled into the inner fiber core of the double-clad fiber, which in this case behaves like a conventional standard fiber, the fiber core of which is surrounded by a low-refractive intermediate cladding. If, however, a laser beam with a wider profile, for example with uniform intensity, is required, the laser beam is coupled into the outer annular core or into both the inner fiber core and the outer annular core. Depending on the application, a laser beam with a filled circular profile according to the inner fiber core, with a ring profile according to the outer annular core, with a filled circular profile according to the two core regions together (with a narrow missing ring due to the first intermediate cladding) or with the corresponding intermediate stages of the above-mentioned profile characteristics can be obtained at the output of the double-clad fiber.

The laser beam can be polarized or unpolarized.

The magnitude of the exit angles and/or the beam displacements of the laser beams from the birefringent optical elements is independent of the polarization of the incident laser beam. The polarization of the incident laser beam only determines the amplitude of the individual exiting laser beams. In a sense, the possible spatial paths of the sub-laser beams and the sub-sub-laser beams are only determined by the geometry of the elements of the device, whereas the input polarization only determines how much power is to be transported along the individual paths.

The first birefringent optical element and/or the second birefringent optical element may comprise quartz glass or be formed from quartz glass.

Quartz glass has a particularly high laser damage threshold, making it particularly suitable for use in laser material machining processes. In addition, quartz glass is particularly easy to machine, so manufacturing costs can be reduced.

The first birefringent optical element and/or the second birefringent optical element may comprise calcite or be formed from calcite.

The first birefringent optical element and/or the second birefringent optical element may comprise barium borate (BBO) or be formed from BBO.

The base thickness of at least one birefringent optical element can be between 1 mm and 50 mm, preferably between 1 mm and 10 mm.

The base thickness is the length of the longest side in the cross-section of an optical element, which is neither the beam entry surface nor the beam exit surface, and the input laser beam and the generated sub-laser beams also lie in the cross-sectional plane.

Such a base thickness enables a particularly robust design of the optical wedges.

For a plane-parallel plate, the base thickness corresponds to the thickness of the plate.

The polarization rotation device can be electronically controlled.

This allows the polarization device to receive and implement electronic control signals. For example, the polarization rotation device can have motorization so that the polarization rotation device can be rotated.

Electronic control can, for example, consist in the polarizations of the sub-laser beams being continuously rotated from the initial polarization state into the final polarization state by the polarization rotation device. In particular, all intermediate polarization states for both sub-laser beams can be adjusted by the polarization rotation device.

However, it is also possible for the polarization of the sub-laser beams to be switched between two states using the polarization rotation device. This can be particularly advantageous when switching between two machining processes.

The polarization rotation device can be a rotatably mounted lambda/2 plate or a Pockels cell.

A Pockels cell is an optoelectronic device which can modify the polarization of a laser beam passing through the Pockels cell by application of a control voltage. In particular, it is possible to rotate the polarization of the laser beam. Consequently, switching or rotation or modification of the polarization may be carried out particularly easily by the voltage control.

In particular, a Pockels cell can obviate moving parts in the device so that particular mechanical stability can be achieved.

The object stated above is also achieved by method for in-coupling a laser beam having features according to the invention. Advantageous further developments of the method arise from the dependent claims, the present description and the figures.

Accordingly, a method is proposed for coupling a laser beam of a laser into a double-clad fiber, wherein the laser beam incident on the beam entry surface of a first birefringent optical element is split into two sub-laser beams, wherein the two sub-laser-beams have first exit angles and/or first beam displacements with respect to the beam exit surface normal, and the two sub-laser-beams are polarized along the base polarization components of the first birefringent optical element, wherein the polarization of the impinging sub-laser-beams is adjusted by a polarization device and thus polarization-adjusted sub-laser beams are provided, wherein the polarization-adjusted sub-laser beams first pass through the beam exit surface of a second birefringent optical element, wherein the first exit angles and/or the first beam displacements of the sub-laser beams from the first birefringent optical element form the second angles of impingement and/or the second beam displacements of the polarization-adjusted sub-laser beams relative to the beam exit surface normal on the second birefringent optical element, wherein the polarization-adjusted sub-laser beams are each split by the second birefringent optical element into two sub-sub-laser beams, wherein the two sub-sub-laser beams each have second exit angles and/or second beam displacements with respect to the beam entry surface normal of the second birefringent optical element, wherein the two sub-sub-laser beams are each polarized along the base polarization components of the second birefringent optical element, and wherein the second exit angles and/or the second beam displacements of the sub-sub-laser beams, the polarization of which corresponds to that of the original sub-laser beams, compensate for the respective first exit angles and/or the first beam displacements, and the sub-sub-laser beams are coupled with a compensated first exit angle and/or first beam displacements into the inner core of the double-clad fiber by an in-coupling optical unit and the other sub-sub-laser beams are coupled into the annular core of the double-clad fiber by the in-coupling optical unit.

The splitting ratio with which the laser beam is coupled into the inner core and into the annular core of the double-clad fiber can be adjusted with the polarization rotation device.

The splitting ratio can be determined from the ratio of the powers of those sub-laser beams which have polarization corresponding to that of the original sub-laser beams and the powers of the other sub-sub-laser beams.

The object stated above is furthermore achieved by a system for machining a material having features according to the invention. Advantageous further developments of the method arise from the dependent claims, the present description and the figures.

Accordingly, a system for machining a workpiece with the laser beam of a laser is proposed, comprising a laser, a double-clad fiber, a device for coupling the laser beam of the laser into the double-clad fiber, a machining optical unit and a workpiece, wherein the coupling device is designed to couple the laser beam of the laser with a splitting ratio into the inner core of the double-clad fiber and into the annular core of the double-clad fiber, wherein the double-clad fiber is designed to guide the laser beam from the input of the double-clad fiber to the output of the double-clad fiber, wherein the machining optical unit is designed to form a machining laser beam from the laser beam after the output of the double-clad fiber, to focus the machining laser beam, and to apply the machining laser beam to the workpiece, and thereby to machine the workpiece.

The machining optical unit enables the laser beam provided by the double-clad fiber to be introduced into the workpiece with the appropriate quality. In particular, the laser beam is introduced into the workpiece in a focal zone in order to machine the workpiece. Only by focusing with a machining optical unit and the resulting convergence of the laser beam into the focal zone is an intensity increase achieved in the focal zone by which the workpiece can be machined.

Machining may, for example, consist in a workpiece being separated along a separation line, or an edge being chamfered, or a predetermined breaking point being generated, or a particularly directed material stress being generated, and so on. The system can also be used, however, to machine, in particular to cut, opaque materials, for example metals or sheet metal. In this case, material is vaporized and ablated by the high-energy excitation of the material of the workpiece.

However, it is also possible for the workpiece to comprise two joining partners which are intended to be joined together. The joining partners may in this case be arranged on one another so that the boundary surfaces of the joining partners, over which the joining partners are to be joined together, face towards one another. Application to the boundary surface can lead to a local melting of the material of the joining partners, the resulting melt bridging the common boundary surface of the joining partners and, when cooled, permanently connecting the joining partners to one another.

The system may also have a feed device, which is designed to move the workpiece and the laser beam relative to one another with a feed along a trajectory, the feed preferably taking place perpendicular to or parallel to the splitting of the laser beam.

By a feed, the laser beam and the workpiece are displaced relative to one another along the trajectory with a feed rate, for example, which, as time passes, gives rise to different impingement locations of the laser beam on the surface of the workpiece.

The splitting ratio with which the sub-sub-laser beams are coupled into the double-clad fiber can be used to adjust the beam quality of the machining laser beam after the output of the double-clad fiber.

Preferred exemplary embodiments are described below with reference to the figures. In this case, elements that are the same, similar or have the same effect are provided with identical reference signs in the different figures, and a repeated description of these elements is omitted in some instances, in order to avoid redundancies.

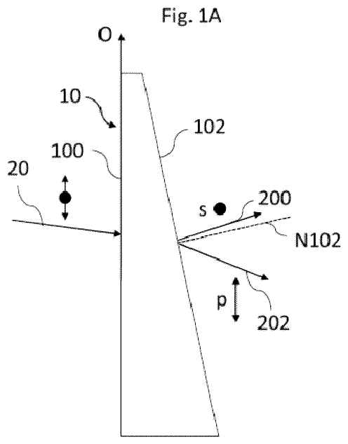

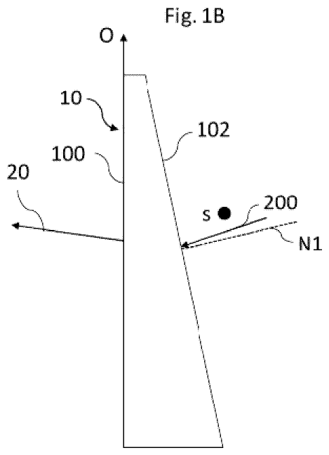

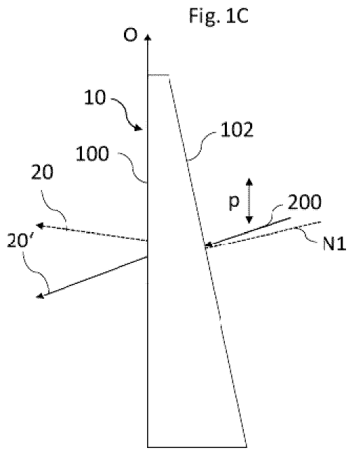

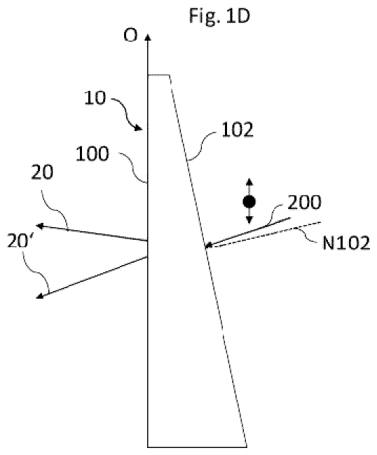

FIGS. 1 to 4 show various aspects of the device 1 according to embodiments of the invention. In particular, the birefringent optical element is represented as a wedge without loss of generality. However, it is clear that an optical wedge as a general embodiment of a plane-parallel plate always includes the properties of the plane-parallel plate.

FIG. 1A schematically shows a first optical wedge 10, the first wedge 12 having a beam entry surface 100 and a beam exit surface 102. The first wedge 10 is designed to split the laser beam 20 incident on the beam entry surface 100 into two sub-laser beams 200, 202. These sub-laser beams 200, 202 have first exit angles with respect to the beam exit surface normal N102.

The sub-laser beams 200, 202 are generated by the birefringent properties of the first optical wedge 10. In this case, the material of the first wedge 10 has different refractive indices for different polarization directions of the incident laser beam 10, so the incident laser beam 10 is split according to the base polarization component of the material of the first wedge 10. The sub-laser beams 200, 202 are therefore polarized along the base polarization components of the first optical wedge 10. Without limiting generality, it is assumed in the following that the sub-laser beam 200 is s-polarized, while the sub-laser beam 202 is p-polarized.

The first exit angles can be determined on the one hand by the entry angle of the incident laser beam 20 and the shape of the beam exit surface 102, in particular the inclination in comparison with the beam entry surface 100. On the other hand, the first exit angles are also determined by the inclination of the optical axis O of the birefringent medium and the relative inclination of the optical axis with respect to the beam exit surface 102. In the present case, the optical axis of the birefringent medium is oriented parallel to the beam entry surface 100. The beam exit surface 102 is therefore at an angle with respect to the optical axis O.

Here, the splitting into the sub-laser beams 200, 202 is independent of the polarization of the incident laser beam 20. The laser beam 20 can therefore be polarized or unpolarized. In any case, in the birefringent medium, only the electric field vector of the incident laser beam 20 is projected onto the optical axis of the optical wedge 10, so the polarization of the incident laser beam 20 only determines the laser power transported along the sub-laser beams 200, 202. However, the magnitude of the spatial splitting always remains the same.

FIG. 1B shows that a sub-laser beam 200, which impinges on the beam exit surface 102 at the exit angle shown with a correspondingly selected polarization, here an s-polarization, exits the optical wedge 10 at the entry angle of the incident laser beam 20. Such a sub-laser beam 200 can therefore pass through the optical wedge 10 backwards.

For comparison, FIG. 1C shows a sub-laser beam 200 which is incident on the beam exit surface 102 at the same exit angle, but has a base polarization that differs for this exit angle, namely a p-polarization. Consequently, the sub-laser beam 200 is not directed onto the path of the incident laser beam 20, but onto the path of another laser beam 20′. The p-polarized laser beam 200 cannot simply pass through the optical wedge backwards, but is deflected.

If, as shown in FIG. 1D, the sub-laser beam 200 has both s-polarization and p-polarization components and impinges on the beam exit surface 102 of the first optical wedge 10 at the exit angle of the s-polarized laser beam, then the s-polarized component can pass through the optical wedge 10 backwards. The p-polarized component, however, is deflected onto a different path as shown in FIG. 1C. The optical wedge 10 splits such sub-laser beams 200 accordingly.

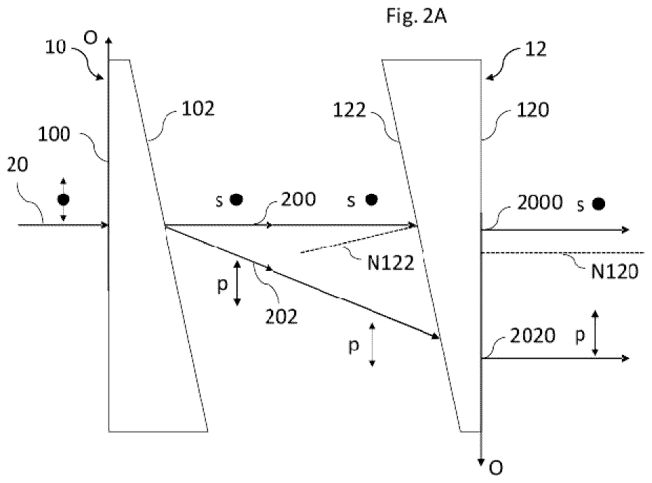

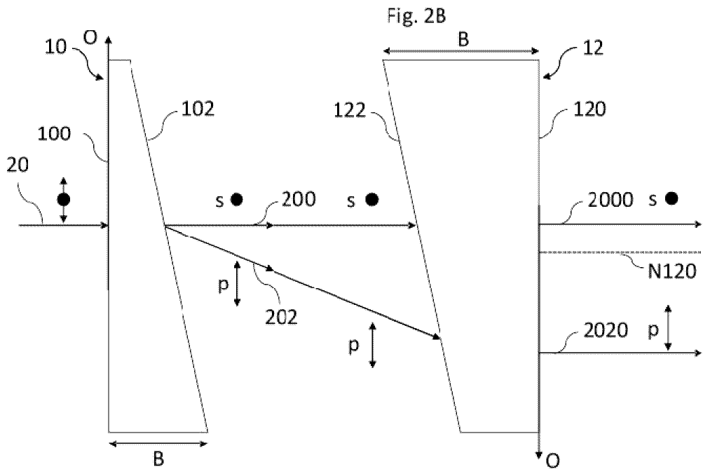

In FIG. 2A, a first optical wedge 10 and a second optical wedge 12 are shown schematically, in which, without loss of generality, it can be assumed at this point that the first wedge 10 and the second wedge 12 are of identical design. The second wedge 12 is simply rotated by 180° in the beam path. This ensures that the first exit angles of the sub-laser beams 200, 202 from the beam exit surface 102 of the first optical wedge 10 correspond to the second angles of impingement of the sub-laser beams 200, 202 onto the beam exit surface 122 of the second optical wedge 12. In a sense, the s-polarized and p-polarized sub-laser beams 200, 202 pass through the second wedge 12 backwards, as shown in FIG. 1B.

However, due to the spatial distance between the first optical wedge 10 and the second optical wedge 12, the sub-laser beams 200, 202 have different impingement locations on the beam exit surface 122 of the second optical wedge 12. However, the two generated sub-sub-laser beams 2000, 2020 run parallel to each other after the second optical wedge 12. In a sense, both sub-sub-laser beams 2000, 2020 run parallel to the originally incident laser beam 20. In other words, the second exit angles of the sub-sub-laser beams 2000, 2020, the polarization of which corresponds to that of the original sub-laser beams, compensate for the respective first exit angles.

FIG. 2B shows a first optical wedge 10 and a second optical wedge 12, in which both wedges are not identical. In particular, the base thickness B of the two optical wedges 10, 12 is different. The base thickness B of at least one optical wedge 10, 12 can be between 1 mm and 50 mm, preferably between 1 mm and 10 mm. The base thickness B of the first optical wedge 10 can be, for example, 5 mm and the base thickness B of the second optical wedge 12 can be 10 mm. In particular, the first optical wedge 10 and/or the second optical wedge 12 may comprise quartz glass or be made of quartz glass. This enables particularly simple and cost-effective production, the optical wedges 10, 12 being, at the same time, particularly insensitive to high laser powers.

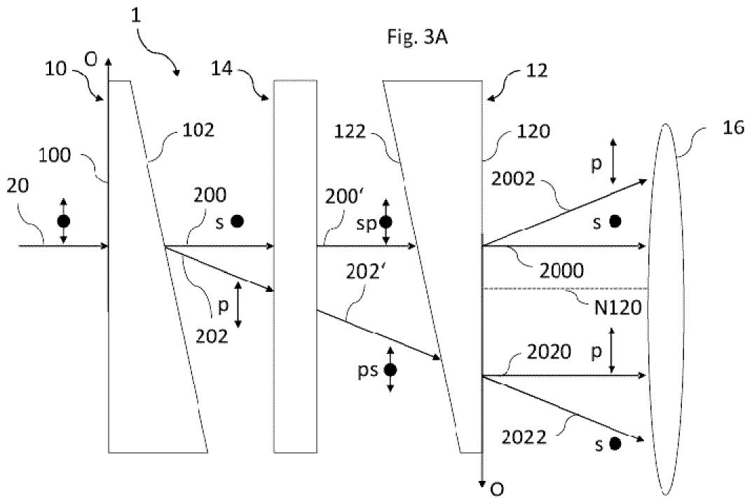

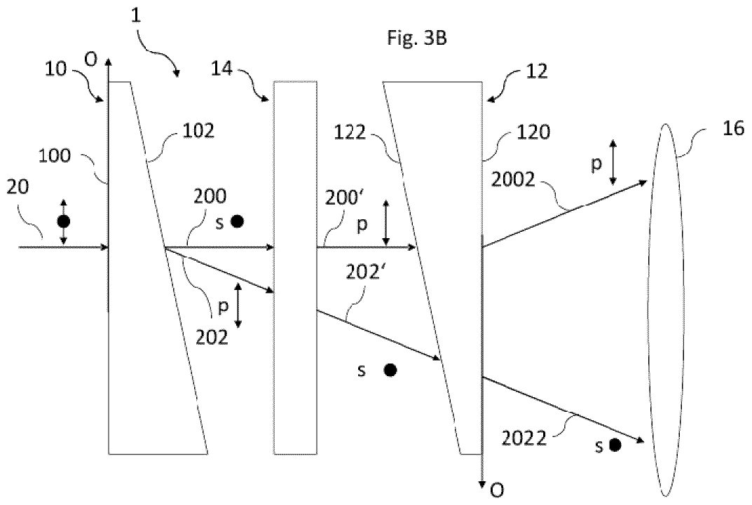

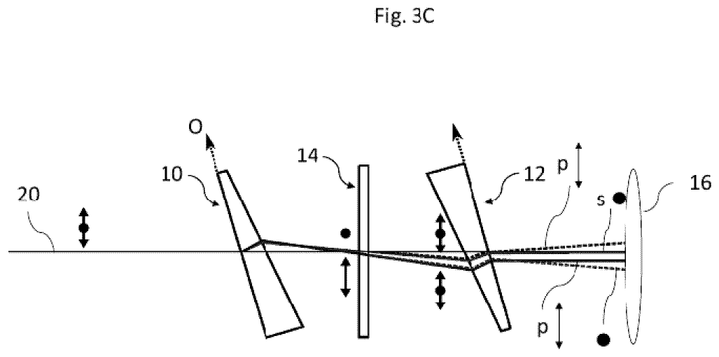

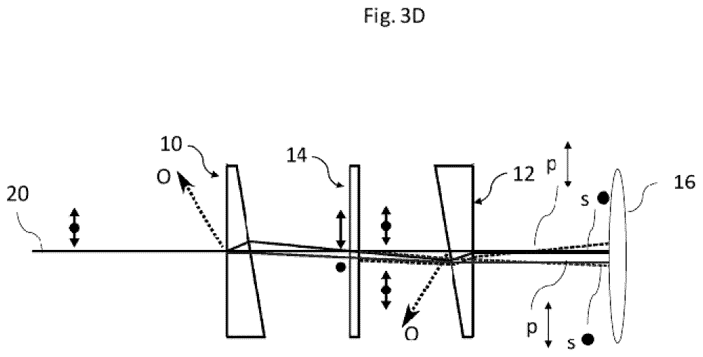

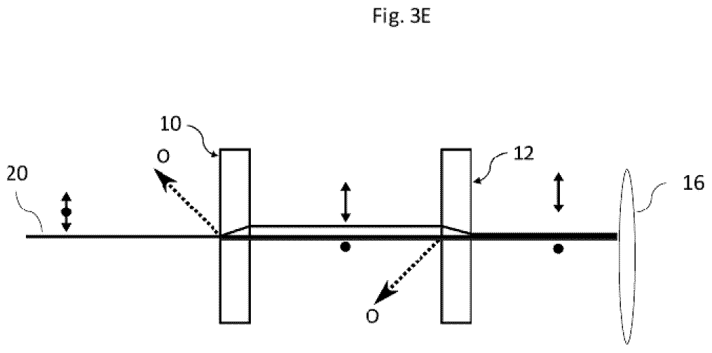

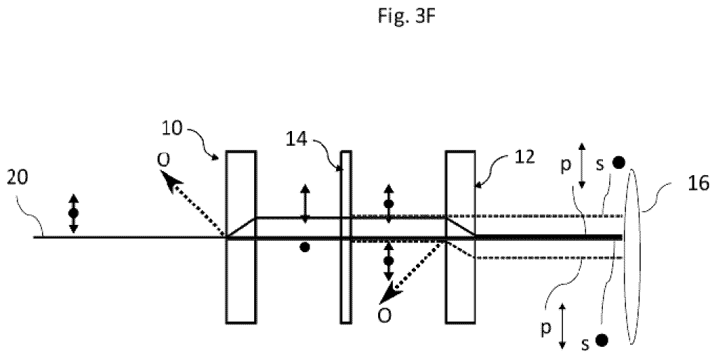

In FIGS. 2A, B, the sub-laser beams 2000, 2020 have the same polarization as the base polarization components of the optical material of the optical wedges 10, 12 associated with the respective paths. In FIG. 3A, however, a polarization rotation device 14 is arranged between the first and second optical wedges 10, 12. The polarization rotation device 14 is configured to rotate the polarization of the sub-laser beams 200, 202 and to provide polarization-adjusted sub-laser beams 200′, 202′.

The polarization of the polarization-adjusted sub-laser beams 200′, 202′ here on the beam exit surface 122 of the second optical wedge 12 only partially corresponds to the base polarization component of the path. The second optical wedge 12 is therefore configured, analogously to the first optical wedge 10, to split the polarization-adjusted sub-laser beams 200′, 202′ each into two sub-sub-laser beams 2000, 2002 and 2020, 2022, the sub-sub-laser beam 2000, 2002, 2020, 2022 being polarized along the base polarization component of the second wedge 12. In this case, the sub-sub-laser beams 2000, 2002, 2020, 2022 have second exit angles with respect to the beam entry surface normal N120 of the beam entry surface 120 of the second wedge 12.

In this case, only the second exit angles of those sub-sub-laser beams 2000, 2020 compensate for the first exit angles which have polarization corresponding to that of the original sub-laser beams 200, 202. The other sub-sub-laser beams 2002, 2022 diverge accordingly.

If the polarization of the sub-laser beams 200, 202 is rotated by the polarization rotation device 14 such that each polarization-adjusted sub-laser beam 200′, 202′ does not have any components polarized according to the required base polarization components, the laser power as a whole is converted into sub-sub-laser beams 2002, 2022 that diverge, i.e., do not run parallel to the incident laser beam 20, as shown in FIG. 3B.

If the polarization of the sub-laser beams 200, 202 is rotated by the polarization rotation device 14 such that each polarization-adjusted sub-laser beam 200′, 202′ has polarized components exactly corresponding to the required base polarization components, the laser power as a whole is converted into sub-sub-laser beams 2000, 2020, the first exit angles of which are compensated for, as shown in FIG. 2A.

The polarization rotation device 14 can be electronically controlled for this purpose. For example, the polarization rotation device 14 can be a rotatably mounted lambda/2 plate, the electronic control of the rotatable bearing allowing the adjustment of a rotation angle, and the rotation of the lambda/2 plate in turn enabling the rotation of the polarization of the sub-laser beams 200, 202. However, it is also possible for the polarization rotation device 14 to be a Pockels cell, in which case a polarization rotation can be adjusted by electronically controlling the Pockels cell.

FIG. 3C shows the situation in which the incident laser beam 20 impinges at an angle of incidence on the beam entry surface of the first optical wedge 10. This makes it possible for both sub-laser beams to exit the optical wedge at an exit angle and also to impinge on the polarization rotation device 14 at the exit angle. There, the polarization direction of the sub-laser beams can be rotated, the polarization-rotated sub-laser-beams then impinging on the second optical wedge 12 at the respective exit angles. By configuring the optical wedges 10, 12, the magnitude of the distance between the parallel sub-laser beams can be adjusted, in particular compared to FIG. 3A, in order to achieve better adaptation of the shape of the sub-sub-laser beams to the double-clad fiber.

In FIG. 3D, the optical wedges are designed analogously to FIG. 3A, but with the difference that the optical crystal axis is not oriented antiparallel. This also allows the magnitude of the distance between the parallel sub-sub-laser beams to be adjusted.

In FIG. 3E, the birefringent optical elements 10, 12 are designed as plane-parallel plates. Here, the optical crystal axes are, for example, at an angle of 45° to the beam entry surface of the plane-parallel plates 10, 12. The incident laser beam 20 is split into two sub-laser beams which are polarized orthogonal to one another and leave the first plane-parallel plate with only a beam displacement but without an exit angle. The two sub-laser beams impinge directly on the second plane-parallel plate, the optical crystal axis of which is rotated in relation to the first crystal axis in such a way that the two sub-laser beams are recombined behind the second plane-parallel plate 12. To a certain extent, the beam displacements and the exit angles of 0° are compensated for.

Owing to the perpendicular impingement of the laser beam, strictly speaking, one can no longer speak of s-polarized and p-polarized components of the incident laser beam, but rather of ordinary and extraordinary beams. The extraordinary beam contains a beam displacement after passing through the plane-parallel plate, while the ordinary beam passes through the plane-parallel plate without a beam displacement. The magnitude of the beam displacement of the two sub-laser beams to each other depends on the difference in the refractive indices, the base thickness of the plane-parallel plate and the orientation of the optical axis.

FIG. 3F shows an embodiment in which a polarization rotation device 14 is arranged between the first and the second plane-parallel plate 10, 12. Owing to the adjusted polarization of the sub-laser beams, analogously to the previous embodiments, the second beam displacements now compensate for those first beam displacements that have associated sub-laser beams with a polarization corresponding to the original polarization of the sub-laser beams. In other words, for example, in the lower s-polarized sub-laser beam, a p-polarized and an s-polarized component is generated by the polarization rotation device 14. Only the first beam displacement of the s-polarized component of the sub-laser beam is compensated for by the second plane-parallel plate and the second beam displacement.

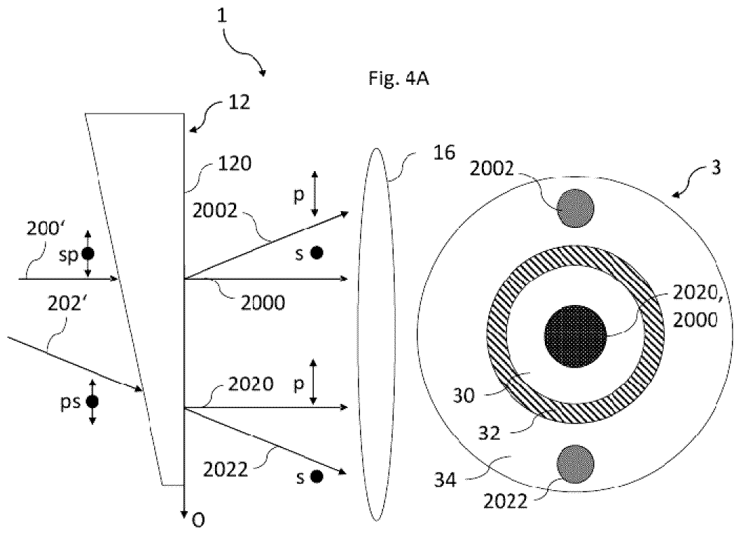

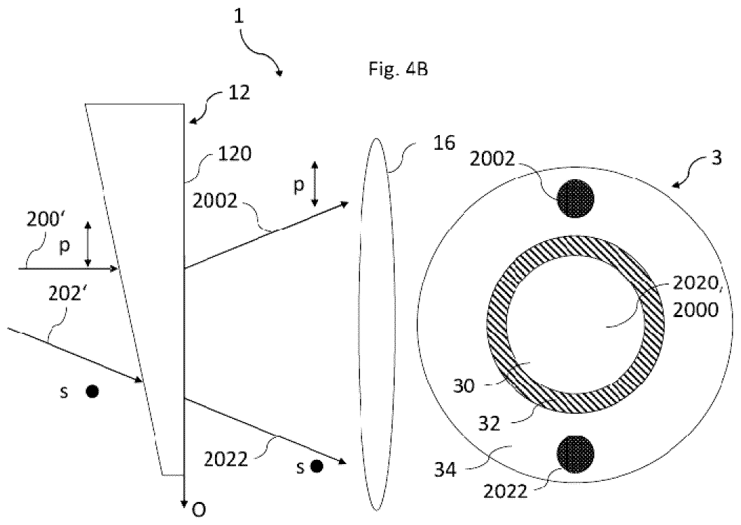

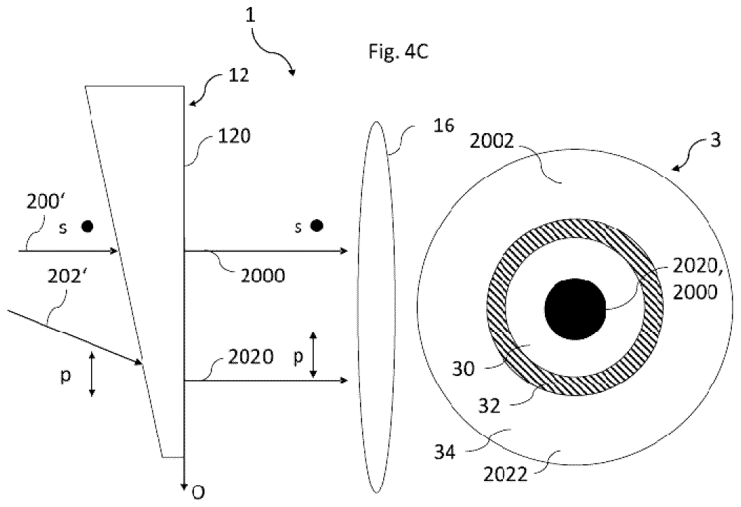

FIGS. 4A, 4B and 4C show that an in-coupling optical unit 16 is arranged behind the second optical wedge 12. The in-coupling optical unit 16 is designed to couple the sub-sub-laser beams 2000, 2020 with a compensated first exit angle into the inner core 30 of a double-clad fiber 3 and to couple the other sub-sub-laser beams 2002, 2022 into the annular core 34 of the double-clad fiber 3.

The in-coupling optical unit 16 can comprise a lens and/or a lens system and/or a mirror arrangement, the in-coupling optical unit comprising only one lens 16 in FIG. 4.

The double-clad fiber shown also has a so-called intermediate cladding between the inner core 30 and the annular core 34, with which intermediate cladding the sub-sub-beams coupled into the various cores of the double-clad fiber are held and guided in the various cores.

By means of the polarization rotation device 14, which is arranged in front of the second optical wedge 12, the total intensity of the sub-sub-laser beams 2020, 2000 with the compensated exit angles can be adjusted relative to the total intensities of the sub-laser beams 2022, 2002 without compensated exit angles.

In particular, the various sub-sub-laser beams 2002 and 2022 propagate as a unit in the annular core 34. This means that the sub-sub-laser-beams 2002, 2022 form a common radiation field and are indistinguishable within the double-clad fiber and also after the double-clad fiber. The same applies to the sub-sub-laser beams 2000, 2020 which are coupled into the inner core of the double-clad fiber. Thus, the polarization rotation device 14 can be used to adjust the power components of the laser beam 20 that are to be coupled into the inner core 30 of the double-clad fiber 3 or the annular core 34 of the double-clad fiber 3. The polarization rotation device 14 can therefore in particular determine the splitting ratio. In particular, the polarization rotation device 14 can be adjusted such that the entire laser power is coupled into the core 30 of the double-clad fiber, or the entire laser power is coupled into the ring 34 of the double-clad fiber.

What is advantageous here is that by splitting the polarization-adjusted sub-laser beams 200′, 202′ into sub-sub-laser beams 2000, 2002, 2020, 2022, a particularly homogeneous power distribution on the entry surface of the double-clad fiber can be achieved. This can reduce the thermal load on the entry surface.

By adjusting the splitting ratio using the polarization rotation device, the beam quality behind the double-clad fiber 3 can also be adjusted. If the part of the laser radiation in the annular core 34 of the double-clad fiber 3 behind the double-clad fiber provides a flat laser beam, while the part of the laser radiation in the inner core 30 of the double-clad fiber provides a collimated laser beam, the overall beam quality can be composed for by adjusting the polarization rotation device 14.

FIG. 4A also shows that the laser power is coupled into the annular core 34 by the sub-sub-laser beams 2002, 2022 at 25% in each case, while the laser power is also coupled into the inner core 30 of the double-clad fiber by the sub-sub-laser beams 2020, 2000 at 25% in each case.

FIG. 4B shows that the laser power is coupled into the annular core 34 by the sub-sub-laser beams 2002, 2022 at 50% in each case, while no laser power is coupled into the inner core 30 of the double-clad fiber.

FIG. 4C shows that none is coupled into the annular core 34, while the laser power is coupled by the sub-sub-laser beams 2020, 2000 at 50% in each case into the inner core 30 of the double-clad fiber.

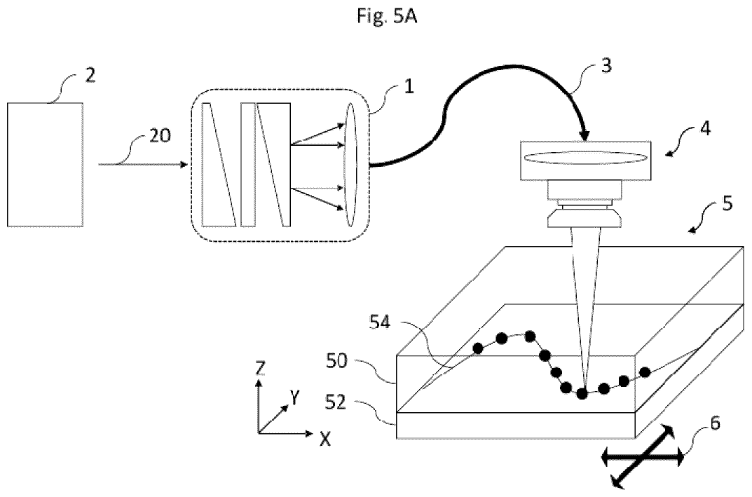

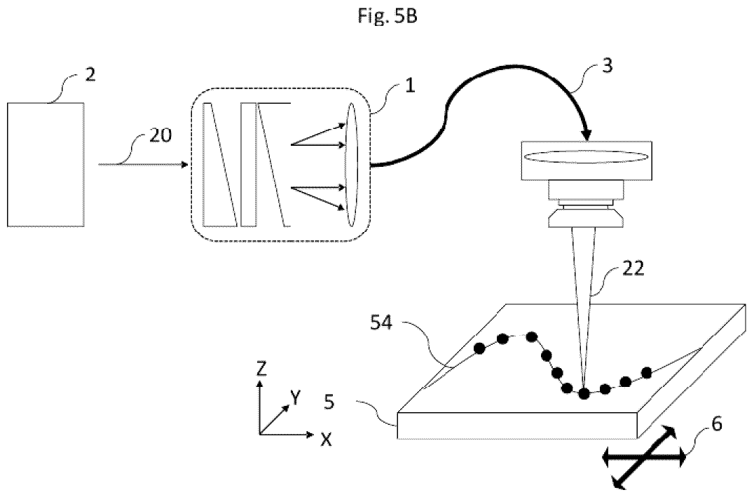

FIG. 5A schematically shows a system according to embodiments of the invention for machining a workpiece 5. In particular, the machining of a workpiece can consist of joining two joining partners. The joining partners 50, 52 in this case are arranged on one another at a common boundary surface.

The laser 2 in this case provides, for example, ultrashort laser pulses. These may be introduced into the boundary layer of the joining partners 50, 52 in the form of a sequence of individual pulses or in the form of a sequence of bursts.

The laser beam 20 of the laser 2 is guided through the device 1 for coupling the laser beam 20 into the double-clad fiber, the device 1 coupling the laser beam 20 into the annular core 34 and the inner core 30 of the double-clad fiber 3 according to the splitting ratio predetermined by the polarization rotation device 14.

The double-clad fiber guides the laser beam 20 to the machining optical unit 4. The machining optical unit can comprise an out-coupling optical unit, with which the laser beam 20 is coupled out of the ring 34 and the core 30 of the double-clad fiber 3. However, the machining optical unit 4 can also be arranged after an out-coupling optical unit. For example, the machining optical unit 4 focuses the laser beam 20 with the beam quality determined by the splitting ratio into the common boundary surface of the two joining partners 50, 52.

In order to focus the laser beam 20 into the common boundary surface of the joining parts 50, 52, the first joining partner 50 in the beam propagation direction must be transparent to the wavelength of the laser 2. For example, the first joining partner 50 may be a glass, a crystal, a ceramic or a plastic. For example, the second joining partner 52 may be opaque or transparent. For example, the second joining partner 52 may be a metal, a semiconductor, a plastic or a ceramic.

At the boundary surface, the laser pulses are absorbed such that the material of the joining partners 50, 52 melts and, over the boundary surface, bonds with the other joining partner 52, 50. As soon as the melt cools, a permanent connection of the two joining partners 50, 52 is formed. In other words, the two joining partners 50, 52 are joined together in this region by welding.

The laser beam and the joining partners may be moved and/or positioned relative to one another by means of a feed device 6 with a feed V of between 0.01 mm/s and 1000 mm/s, preferably between 0.1 mm/s and 300 mm/s. For this purpose, the joining partners may, for example, be positioned on a feed device 6. This can achieve the result that the laser beam 20 is moved over the joining partners 50, 52 along a joining seam so that the joining partners 50, 52 can be joined along the joining seam.

FIG. 5B schematically shows the system according to embodiments of the invention for machining a workpiece 5, in which the machining here consists in separating a workpiece 5. In this case, analogously to FIG. 5A, the laser beam 20 is introduced into the workpiece 5 along a trajectory 54 along which the material is to be separated. By introducing the laser beam 20, the workpiece 5 is damaged in a targeted manner along the trajectory so that the workpiece 5 can be separated along the trajectory 54.

In order to switch between the machining processes of FIG. 5A and FIG. 5B, only one adjustment of the polarization rotation device 14 has to be made, so there is no refitting effort.

Insofar as applicable, all individual features presented in the exemplary embodiments may be combined with one another and/or interchanged.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Device
10 First birefringent optical element
100 Beam entry surface
102 Beam exit surface
12 Second birefringent optical element
120 Beam entry surface
122 Beam exit surface
14 Polarization rotation device
16 In-coupling optical unit
2 Laser
20 Incident laser beam
200 Sub-laser beam
200′ Polarization-adjusted sub-laser beam
2000 Sub-sub-laser beam
2002 Sub-sub-laser beam
202 Sub-laser beam
202′ Polarization-adjusted sub-laser beam
2020 Sub-sub-laser beam
2022 Sub-sub-laser beam
22 Machining laser beam
3 Double-clad fiber
30 Inner core
32 Intermediate cladding
34 Annular core
4 Machining optical unit
5 Workpiece
50 First joining partner
52 Second joining partner
54 Trajectory
6 Feed device
B Base thickness
N1 Beam exit surface normal
O Optical axis of the birefringent medium

1. A device for coupling a laser beam of a laser into a double-clad fiber, the device comprising:
a first birefringent optical element configured to split the laser beam incident on a beam entry surface into two sub-laser beams, wherein the two sub-laser beams have first exit angles and/or first beam displacements with respect to a beam exit surface normal, wherein the two sub-laser beams are polarized along base polarization components of the first birefringent optical element,
a polarization rotation device configured to adjust a polarization of the sub-laser beams to provide polarization-adjusted sub-laser beams,
a second birefringent optical element, wherein a beam exit surface of the second birefringent optical element is first passed through by the polarization-adjusted sub-laser beams, and the first exit angles and/or the first beam displacements of the sub-laser beams from the first birefringent optical element are second angles of impingement and/or second beam displacements of the polarization-adjusted sub-laser beams relative to a beam exit surface normal of the second birefringent optical element,
wherein the second birefringent optical element is configured to split each of the polarization-adjusted sub-laser beams into two sub-sub-laser beams, wherein the two sub-sub-laser beams have second exit angles and/or second beam displacements with respect to a beam entry surface normal of the second optical wedge, wherein the two sub-sub-laser beams are polarized along base polarization components of the second birefringent optical element, and
wherein the second exit angles and/or the second beam displacements of the sub-sub-laser beams, a polarization of which corresponds to the polarization of the two sub-laser beams, compensate for the respective first exit angles and/or the first beam displacements, and
an in-coupling optical unit configured to couple the sub-sub-laser beams with compensated first exit angles and/or first beam displacements into an inner core of the double-clad fiber, and to couple other sub-sub-laser beams into an annular core of the double-clad fiber.

2. The device according to claim 1, wherein the laser beam is polarized or unpolarized.

3. The device according to claim 1, wherein the first birefringent optical element and/or the second birefringent optical element comprises quartz glass or is formed from quartz glass.

4. The device according to claim 1, wherein a base thickness of at least one of the first birefringent optical element and the second birefringent optical element is between 1 mm and 50 mm.

5. The device according to claim 1, wherein the first birefringent optical element and the second birefringent optical element are configured identically.

6. The device according to claim 1, wherein the polarization rotation device is electronically controllable.

7. The device according to claim 1, wherein the in-coupling optical unit comprises a lens and/or a lens system and/or a mirror arrangement.

8. The device according to claim 1, wherein the double-clad fiber comprises an intermediate cladding.

9. A method for coupling a laser beam of a laser into a double-clad fiber, the method comprising:
splitting the laser beam incident on a beam entry surface of a first birefringent optical element into two sub-laser beams, wherein the two sub-laser beams have first exit angles and/or first beam displacements with respect to a beam exit surface normal, wherein the two sub-laser-beams are polarized along base polarization components of the first birefringent optical element,
adjusting a polarization of the sub-laser beams with a polarization rotation device to provide polarization-adjusted sub-laser beams,
wherein the polarization-adjusted sub-laser beams first pass through a beam exit surface of a second birefringent optical element, wherein the first exit angles and/or the first beam displacements of the sub-laser beams from the first birefringent optical element are second angles of impingement and/or second beam displacements of the polarization-adjusted sub-laser beams relative to a beam exit surface normal on the second birefringent optical element,
wherein each of the polarization-adjusted sub-laser beams is split by the second birefringent optical element into two sub-sub-laser beams, wherein the two sub-sub-laser beams have second exit angles and/or second beam displacements with respect to a beam entry surface normal of the second optical wedge, wherein the two sub-sub-laser beams are polarized along base polarization components of the second optical wedge, and
wherein the second exit angles and/or the second beam displacements of the sub-sub-laser beams, a polarization of which corresponds to the polarization of the sub-laser beams, compensate for the respective first exit angles, and
the sub-sub-laser beams with compensated first exit angles and/or first beam displacements are coupled into an inner core of the double-clad fiber with an in-coupling optical unit, and the other sub-laser beams are coupled into an annular core of the double-clad fiber with the in-coupling optical unit.

10. The method according to claim 9 wherein a splitting ratio with which the laser beam is coupled into the inner core and into the annular core of the double-clad fiber is adjusted with the polarization rotation device.

11. The method according to claim 10, wherein the splitting ratio is determined from a ratio of powers of the sub-sub-laser beams having the polarization which corresponds to the polarization of the sub-laser beams, and the powers of the other sub-sub-laser beams.

12. A system for machining a workpiece with the laser beam of a laser, the system comprising a laser, a double-clad fiber, a device for coupling the laser beam of the laser into the double-clad fiber according to claim 1, a machining optical unit, and a workpiece,
wherein the device is configured to couple the laser beam of the laser with a splitting ratio into the inner core of the double-clad fiber and into the annular core of the double-clad fiber,
wherein the double-clad fiber is configured to guide the laser beam from an input of the double-clad fiber to an output of the double-clad fiber, and
wherein the machining optical unit is configured to form a machining laser beam from the laser beam after the output of the double-clad fiber, to focus the machining laser beam, and to apply the machining laser beam to the workpiece, thereby to machine the workpiece.

13. The system according to claim 12, wherein the splitting ratio is used to adjust a beam quality of the machining laser beam after the output of the double-clad fiber.
